(19) United States
(12) Patent Application Publication
(10) Pub. No.: US 2012/0290913 A1
(43) Pub. Date: Nov. 15, 2012

(54) COMPUTERIZED TOOL, SYSTEM AND METHOD FOR REMOTE ACCESS TO A COMPUTER PROGRAM

(76) Inventor: Yosef Benraz, Herzelia (IL)

(21) Appl. No.: 13/514,984

(22) PCT Filed: Dec. 9, 2010
(86) PCT No.: PCT/IL10/01040

§ 371 Date: Jun. 10, 2012

Related U.S. Application Data
(60) Provisional application No. 61/286,159, filed on Dec. 14, 2009.
(60) Provisional application No. 61/328,283, filed on Apr. 27, 2010.

(51) Int. Cl. G06F 17/00

(52) U.S. Cl. 715/222

(57) ABSTRACT

A computerized tool, system and method for virtual wrapping of a computer program, the computerized tool comprising: an event agent to identify a computer program running; and a form generator controlled by the event agent to automatically create a virtual wrap in web-page and/or win forms for the computer program, the virtual wrap comprising virtual objects which correspond to objects in the program, wherein the event agent controls the transmission of events from virtual objects in the virtual wrap to corresponding objects in the program and vice versa.

### BACKGROUND OF THE INVENTION

In many known computer remote controlling tools, a user receives into his work station a picture of the display of the remotely controlled computer. When the user performs operations in objects, the operation is transmitted to the remotely controlled computer and an updated picture or part of the picture (some divide the picture to small parts and send only the parts had changes within it) is sent back to the user's work station, showing the display of the remotely controlled computer after the operation has been performed.

This process may be very slow and inefficient, and may cause many delays and obstacles to fluent work. Therefore, users may refrain from performing major tasks on a remote computer.

Additionally, the known remote controlling tools do not enable adaptations, modifications and/or updates of the display and of objects in the display of the remotely controlled computer in the user's work station.

The known remote controlling tools do not enable targeted advertisements on the display according to the display content of the running program in the remotely controlled computer in the user's work station.

Therefore, a remote access tool is needed which may enable efficient and fast remote controlling of a computer and adaptations of the display of the remotely controlled computer in the user's work station.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic block illustration of a computer program wrapping tool for virtual wrapping of a computer program for remote access to a computer program according to some embodiments of the present invention;

FIG. 2 is a flow chart illustrating a method for computer program wrapping for remote access to a computer program according to embodiments of the present invention.

FIG. 3 is a schematic block illustration of a system for remote access to a computer program according to some embodiments of the present invention;

FIG. 4 is a flow chart illustrating a method according to some embodiments of the present invention; and

FIG. 5 is an exemplary illustration of a remote access application for remote access to a computer program according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits have not been described in detail so as not to obscure the present invention.

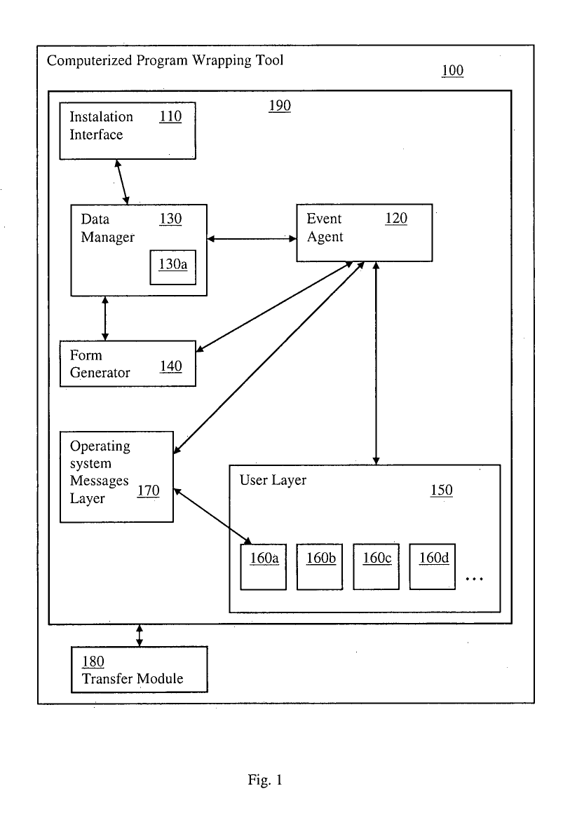

Reference is now made to FIG. 1, which is a schematic block illustration of a computerized program wrapping tool 100 for virtual wrapping of a computer program for remote access to a computer program according to some embodiments of the present invention. Program wrapping tool 100 is able to wrap a computer program in a virtual wrap, for example create for the computer program a window form or a web page form wrap, which may replace, for example, the original display and/or interface of the computer program, and in which the computer program interface can be displayed according to a user's preferences. For example, the objects in the virtual wrap can be arranged differently then in the original form of the computer program, and/or only some of the objects can be presented. For example, the text and/or the language of the text objects in the virtual wrap may be different then the text and/or language of the text objects in the original form of the computer program. For example, any other parameter of the objects in the program interface, such as color, design, form, location, size or any other suitable parameter, can be changed in the virtual wrap according to the user's preferences.

The virtual wrap may run on the same work station on which the computer program is running. In some embodiments of the present invention, connection to the original work station from a remote computer may be done, for example, by web browsing, by connecting to the virtual wrap which may be, for example, in a web-page form.

Computerized program wrapping tool 100 may be, for example, a computer program which may be stored in a general purpose computer or in an apparatus which may be specially constructed for the desired purposes. Computerized program wrapping tool 100 may be stored in a computer readable storage medium, such as, but not limited to, any type of disk, including floppy disks, optical disks, magnetic-optical disks, read-only memories (ROM's), compact disc read-only memories (CD-ROM's), random access memories (RAM's), electrically programmable read-only memories (EPROM's), electrically erasable and programmable read only memories (EEPROM's), FLASH memory, magnetic or optical cards, or any other type of media suitable for storing.

Additionally or alternatively, although the scope of the present invention is not limited in this respect, computerized program wrapping tool 100 may be implemented in many wireless, handheld and portable communication devices. By way of example, wireless, handheld and portable communication devices may include wireless and cellular telephones, smart telephones, personal digital assistants (PDAs), web-tablets and any device that may provide wireless access to a network such, an intranet or the internet. It should be understood that the present invention may be used in a variety of applications.

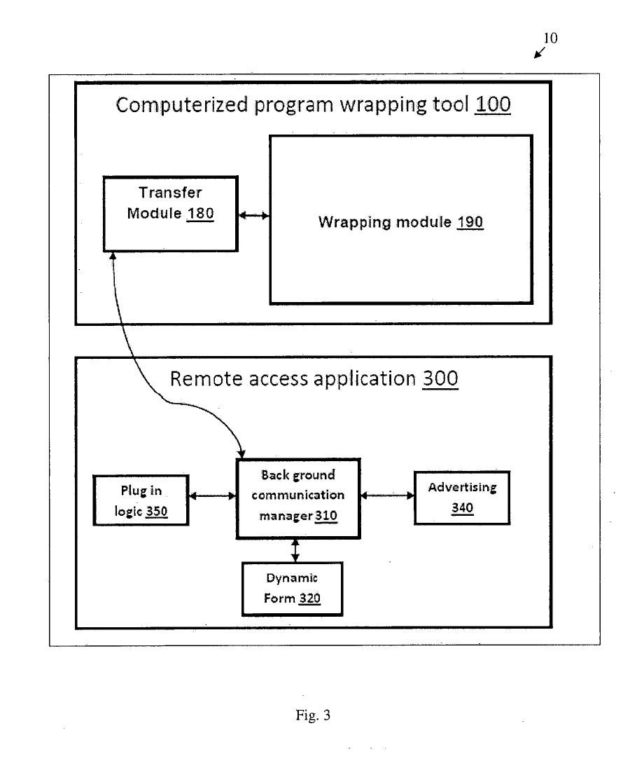

Computerized program wrapping tool 100 may include wrapping module 190 which may be able to wrap a computer program. Wrapping module 190 may identify a running program and analyze the objects within the running program. Then, wrapping module 190 may create a virtual wrap corresponding to the running program. The virtual wrap may include objects, herein referred to as “virtual objects”, wherein each virtual object may execute events correspondingly to events performed by/on a corresponding objects in the running program, herein referred to as “real objects”. Additionally, wrapping tool 100 may include a transfer module 180 which, in some embodiments of the present invention, may transfer to a remote access application the data and/or information needed to build and/or run a virtual wrap, for example on a remote work station, as described in detail herein below with reference to FIG. 3.

Wrapping module 190 may include an operating system message layer 170 which may control operation of computer programs and a user layer 150 in which a user may interface with computer programs. In user layer 150, a user may choose computer programs, for example, at least one of programs 160a, 160b, 160c and/or 160d, to be wrapped by wrapping tool 100.

Wrapping module 190 may further include an installation interface 110, an event agent 120, a data manager 130 and a form generator 140. Data manager 130 may manage a data base 130a and may be adapted to search for data, extract data, store data and/or update data in data base 130a.

Event agent 120 may control data manager 130. For example, event agent 120 may request data manager 130 to search for data, extract data, store data and/or update data in data base 130a. Additionally, event agent 120 may control form generator 140, for example by sending instructions and data to form generator 140, based on which form generator 140 may create the virtual wraps.

Event agent 120 may identify a program chosen by the user, for example, program 160a. Event agent 120 may request data manager 130 to search data base 130a for previously defined virtual wrap(s) for program 160a and/or wrapping instructions relating to program 160a, for example, instructions to run program 160a in a specific form and/or language, for example a different form and/or language from the primary form and/or language of program 160a. In case previously defined virtual wrap(s) and/or wrapping instructions relating to program 160a are stored in data base 130a, event agent 120 may present the virtual wrap(s) to the user or request form generator 140 to create a virtual wrap based on previously defined instructions, and present the generated wrap to the user. In case more then one predefined virtual wrap is stored in data base 130a for program 160a, event agent may present the virtual wraps to the user, who may choose a virtual wrap from the predefined virtual wraps or instruct to generate another virtual wrap. The user may also choose one of the predefined virtual wraps to be the default wrap to be used absent other instructions from the user. The default instructions may be stored in data base 130a and extracted when needed by data manager 130.

In case data base 130a does not include previously defined virtual wrap(s) for program 160a and/or wrapping instructions relating to program 160a, form generator 140 may create, for example upon a request received from event agent 120, a suitable virtual wrap for program 160a. For example, absent other instructions from the user, form generator 140 may automatically create a virtual wrap which substantially correspond to the original form of computer program 160a, for example, in arrangement, form, color, language or any other suitable parameter of the different objects and/or elements of the original form. The automatically generated wrap may be substantially identical to the original form of computer program 160a. Alternatively, a user may provide default instructions for the arrangement, form, color, language or any other suitable parameter of a new virtual wrap generated by form generator 140. Form generator 140 may create the virtual wrap based on the default instructions provided by the user. The default instructions may be stored in data base 130a and extracted when needed by data manager 130.

Form generator 140 may create a virtual wrap for a computer program, wherein the virtual wrap may include, for example, virtual objects as defined above. Form generator 140 may create the virtual wrap automatically, for example, upon a request from event agent 120, by dynamically creating, based on the original wrap form of the computer program, resource files which include mechanisms which can be loaded or/and run and/or executed by a web browser. The original form of the computer program may be, for example, in a window form. The mechanisms which may be included in the dynamically created resource files may be files and/or scripts which may include language and/or format and/or syntax and/or markup language and/or any other standard supported by common internet browsers. In this description, the term “resource file” refers to a resource file which may be stored in any computer readable storage medium, such as, but not limited to, any type of disk, including floppy disks, optical disks, magnetic-optical disks, read-only memories (ROM's), compact disc read-only memories (CD-ROM's), random access memories (RAM's), electrically programmable read-only memories (EPROM's), electrically erasable and programmable read only memories (EEPROM's), FLASH memory, magnetic or optical cards, or any other type of media suitable for storing.

More specifically, in some embodiments of the present invention, form generator 140 may create a web form dynamically by automatically programming the web form by using language supported by a web browser, thus, for example, creating objects within a web form wrap running by WEB Browser. These objects, referred herein by the term “virtual object(s)”, may perform events, for example, depending on the object type (e.g. click, double click, change text, scroll down/up, etc.). Event agent 120 may pass those events from the virtual objects to corresponding objects in the original program form, for example by any suitable available communications tool and/or protocol.

Event agent 120 may present the generated virtual wrap to the user, who may instruct to change the generated wrap or to create another one. Any virtual wrap generated by form generator 140 may be stored in data base 130a, automatically or upon instructions received from the user.

As mentioned above, form generator 140 may translate the text in the original program form to another language, for example, based on instructions received from a user and/or stored in data base 130a. Thus, for example, form generator 140 may create the virtual wrap with text objects in another language than in the original form. Additionally, form generator 140 may automatically change alignment of text or object in accordance with the language of the created virtual form and/or make any other suitable language dependent changes. Additionally, the text itself and/or the size, font, color of the text can be changed in the virtual wrap by form generator 140 based on instructions received from a user or stored in database 130a.

Any virtual wrap created by form generator 140 may include virtual objects which correspond to objects in program 160a. In case the virtual wrap run on the same work station on which program 160a is running, for example instead of the original form of program 160a, program 160a may be run in the background, while the user sees only the virtual wrap. In case the virtual wrap run on a remote computer, for example, in a web page form, program 160a may run on the computer on which it is installed, and may be controlled remotely from the remote computer, for example by web-browsing, by controlling virtual objects of the virtual wrap by a user. Event agent 120 may control the transmission of events, for example such as operations and updates, from virtual objects in the virtual wrap to the corresponding objects in program 160a, and vice versa, for example by any suitable available communications tool and/or protocol. Relation data between the virtual objects and the corresponding actual objects in program 160a may be stored in data base 130a and extracted when needed by data manager 130.

The virtual objects may operate according to control messages provided by operating system. Event agent 120 may receive the control messages from message layer 170 and transmit the control messages from the virtual objects to the corresponding objects in program 160a and vice versa, so that the virtual objects and the actual objects in program 160a will operate correspondingly according to the control messages. Additionally, any data update of a virtual object may be transmitted by event agent 120 to the corresponding actual object in program 160a, which may be updated accordingly, and vice versa. Therefore, for example, computerized wrapping tool 100 may convert a window form of a program (which may be, for example, the original form or a virtual wrap) to a web-page form wrap and vice versa, wherein each object in the web-form wrap correspond and/or operate correspondingly to a respective object in the window form or a virtual wrap.

Additionally, computerized wrapping tool 100 may create a web page form or window form virtual wrap for a desktop, for example, a virtual desktop which may represent an original desktop of a remote computer. For example, at least some of the shortcuts displayed on the original desktop may have corresponding virtual shortcuts displayed on the virtual wrap/interface. A user may choose a program by clicking on a virtual shortcut. Event agent 120 may transmit a message to the remote computer, thus initiating the operation of the computer program. Once the operation of a computer program is initiated, a virtual wrap for the program may be created and/or presented to the user as described in detail above.

For example, computerized wrapping tool 100 may create the virtual desktop as a main page of a website, in which the virtual shortcuts of the computer programs may be presented. When a user clicks on a virtual shortcut, the operation of the respective computer program may be initiated and the web page virtual wrap of the program may be presented.

Installation interface 110 may enable a user to add to data base 130a externally user-made wraps, such as designed web pages and/or window forms. For example, a user may design a specific web page or window interface for a specific computer program and store it in data base 130a, for example so that event agent 120 may extract the externally made wrap when the specific program is running, for example instead of using form generator 140 for creating a virtual wrap for the computer program.

Additionally or alternatively, installation interface 110 may enable a user to add to data base 130a pre-designed object forms which form generator 140 can use in generation of virtual wraps. For example, the pre-designed objects may be of an unstandard form and/or form object which cannot be created by form generator 140. For example, a user may add to data base 130a pre-designed object forms to represent specific objects in a program, which may have an unstandard form which is unknown to form generator 140. Form generator 140, when creating a virtual wrap to the program, may use the pre-designed object forms in the generated virtual wrap.

In some embodiments of the present invention installation interface 110 may also enable a user to add products, software and/or programs to the virtual desktop, additionally to the computer programs in the original desktop. Additionally, installation interface 110 may enable updating of the user-made virtual wraps and the user-added products, software and/or programs.

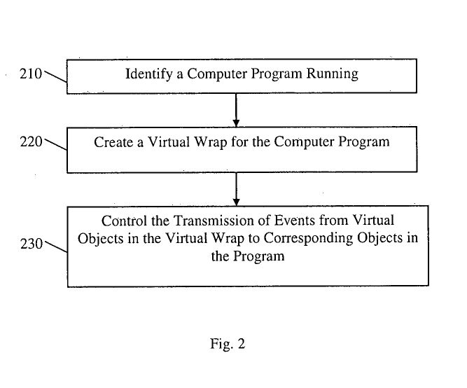

Reference is now made to FIG. 2, which is a flow chart illustrating a method for computer program wrapping for remote access to a computer program according to embodiments of the present invention. As illustrated in block 210, the method may include the step of identifying a computer program running, for example by event agent 120 as described in detail above. As illustrated in block 220, the method may include the step of creating a virtual wrap for the computer program, for example by form generator 140 and/or according to instructions from a user as described in detail above. For example, predefined virtual wrap and/or wrapping instructions can be extracted from data base 130a by data manager 130, as described in detail above. As described in detail above with reference to FIG. 1, the virtual wrap may include virtual objects which correspond to objects in the program. As illustrated in block 230, the method may include the step of controlling the transmission of events from virtual objects in the virtual wrap to corresponding objects in the program, for example by event manager 120, as described in detail above with reference to FIG. 1.

Reference is now made to FIG. 3, which is a schematic block illustration of a computerized system 10 for remote access to a computer program according to some embodiments of the present invention. Remote access system 10 may include computerized program wrapping tool 100 described above with reference to FIGS. 1 and 2 and a remote access application 300. Remote access application 300 may be executed on a different (for example, remote) work station than computerized program wrapping tool 100. Computerized wrapping tool 100 may create a virtual wrap of a running program and send information regarding the virtual wrap to remote access application 300, which may build and run the virtual wrap based on the received information.

Computerized program wrapping tool 100 may include wrapping module 190 which may be able to wrap a computer program as described above with reference to FIG. 1. Additionally, wrapping tool 100 may include a transfer module 180 which may transfer to remote access application 300 the data and/or information needed to build and/or run a virtual wrap, for example on the remote work station. Additionally, during operation of the virtual wrap, information regarding any event initially occurring in a virtual object of the virtual wrap may be transmitted by transfer module 180 to the corresponding real object in the running program, in order to perform the same event in the real object. Similarly, any event initially occurring in a real object of the running program may be transmitted by transfer module 180 to the corresponding virtual object of the virtual wrap, in order to perform the same event in the virtual object. Correspondence and/or relation data between real and virtual objects may be stored in data base(s) accessible by wrapping tool 100 and/or remote access application 300.

Remote access application 300 may include a background communication manager 310, a dynamic form module 320, an advertising module 340 and a plug-in logic module 350. Background communication manager 310 may control the data transactions to and from transfer module 180. Additionally it may manage other connections to data bases internal or external to the remote work station. For example; Background communication manager 310 may manage the connection with targeted advertisements databases and/or providers and/or plug in logic purposes.

The data and/or information needed in order to build/run the virtual wrap and/or to coordinate events between real objects and virtual objects, for example as described above, may be received by dynamic form module 320 through background communication manager 310. Dynamic form module 320 may create and/or run the virtual wrap based on the received information, perform events at the virtual objects, and communicate information regarding events in the virtual objects to transfer module 180 via background communication manager 310. Creation of the virtual wrap may include recreation of the virtual wrap based on information received from transfer module 180 and/or importing of elements of the virtual wrap from wrapping tool 100 through transfer module 180. The information received by dynamic form module 320 may include information required for creation of the virtual objects to be coordinated with the corresponding real objects of the running program.

Remote access application 300 may be or include a web page or a window form located in a local machine and/or other remote machine (server and/or work station) in a remote access application, and/or a web page within an existing web application and/or website (such as Facebook, Gmail, Linkedln or any other website). As described above, remote access application 300 may build and/or run a virtual wrap according to information received from wrapping tool 100, thus, for example, exporting a window form or a web page form wrap for the running computer program, herein referred to as a virtual wrap. The virtual wrap may imitate, for example, the original display and/or interface of the computer program. However, in the virtual wrap, the computer program interface can be displayed according to a user's preferences. For example, the objects in the virtual wrap within remote access application 300 can be arranged differently then in the original form of the computer program, and/or only some of the objects can be presented. For example, the text and/or the language of the text objects in the virtual wrap within remote access application 300 may be different then the text and/or language of the text objects in the original form of the computer program. For example, any other parameter of the objects in the program interface, such as color, design, form, location, size or any other suitable parameter, can be changed in the virtual wrap within remote access application 300 according to the user's preferences.

The remote access application 300 may run in the same workstation in which the computer program to be wrapped and/or wrapping tool 100 run. Additionally or alternatively, although the scope of the present invention is not limited in this respect, remote access application 300 may be implemented in many wireless, handheld and portable communication devices. By way of example, wireless, handheld and portable communication devices may include wireless and cellular telephones, smart telephones, personal digital assistants (PDAs), web-tablets and any device that may provide wireless access to a network such, an intranet or the internet. It should be understood that the present invention may be used in a variety of applications.

Remote access application 300 may be implemented as a web base application, window form and/or mobile devices oriented.

Transfer module 180 within virtual wrapping tool 100 may be a virtual module, i.e. not necessarily implemented in a real system. The format of transfer module 180 may depend on the limitations such as security and communication technology.

In some embodiments of the present invention, for example, if remote access application 300 runs in the same system where wrapping tool 100 runs, the communication of wrapping tool 100 with dynamic form module 320 may be performed directly, for example without passing through transfer module 180.

Dynamic form module 320 may dynamically and automatically create the virtual wrap, for example, based upon data received from transfer module 180 and based on the original wrap form of the computer program running in the remote computer. The original form of the computer program may be, for example, in a window form. Event agent 120 within wrapping tool 100 may control dynamic form module 320 via transfer module 180, for example by sending instructions and data to dynamic form module 320, based on which dynamic form module 320 may create the remote virtual wraps.

In some embodiments of the present invention, remote application 300 may be a window or web application within a website. Dynamic form module 320 may be a module within or part of the window application and/or the web application within a website. Dynamic form module 320 may create said virtual wrap automatically by dynamically creating virtual objects for controlling corresponding real objects in the computer program via transfer module 180, which may pass the events to and from event agent 120.

In some embodiments of the present invention, dynamic form module 320 may dynamically create based on the original wrap form of the computer program, for example upon a request from wrapping tool 100, resource files which include mechanisms which can be loaded or/and run and/or executed by a web browser. The target form of the virtual form created by Dynamic Form 320 may be, for example, in a window form. The mechanisms which may be included in the dynamically created resource files may be files and/or scripts which may include language and/or format and/or syntax and/or markup language and/or any other standard supported by common internet browsers and/or operating system oriented. In this description, the term “resource file” refers to a resource file which may be stored in any computer readable storage medium, such as, but not limited to, any type of disk, including floppy disks, optical disks, magnetic-optical disks, read-only memories (ROM's), compact disc read-only memories (CD-ROM's), random access memories (RAM's), electrically programmable read-only memories (EPROM's), electrically erasable and programmable read only memories (EEPROM's), FLASH memory, magnetic or optical cards, or any other type of media suitable for storing.

Dynamic form module 320 may present the generated virtual wrap to the user, who may instruct to change the generated wrap or to create another one. Any virtual wrap generated by Dynamic Form 320 may be stored in data base 130a, automatically or upon instructions received from the user via transfer module 180. Additionally or alternatively, virtual wrap generated by dynamic form module 320 may be stored in data base within virtual wrapping tool 100, such as locally in the client work station and/or in other server connected to client work station via background communication manager 310.

The virtual objects in the remote access application 300 may operate according to control messages provided by an operating system of the remote station in which remote access application 300 is operating. An event agent of wrapping tool 100 may receive via transfer module 180 the control messages and transmit the control messages from the virtual objects to the corresponding real objects in the running program and vice versa, so that the virtual objects and the real objects may operate correspondingly according to the control messages. Additionally, any data update of a virtual object may be transmitted via transfer module 180 to the corresponding real object, which may be updated accordingly, and vice versa.

In some embodiments of the invention, remote access application 300 may create a virtual desktop, in which the virtual shortcuts of the computer programs may be presented. When a user clicks on a virtual shortcut, the operation of the respective computer program may be initiated on the computer on which it is installed and the virtual wrap of the program may be presented in the remote access application 300 in the remote computer.

A virtual form created by dynamic form module 320 may be include the virtual wrap for a computer program, an advertising portion to display targeted advertisements and banners, and logic plug-in portion for logical objects.

Plug-in logic 350 may enable a user to add new logical objects to the remote virtual wrap, for example in a dedicated portion of the virtual form or in any suitable location on the virtual form. Plug-in logics may have their own functionality and may be stored in a data base accessible by dynamic form module 320. Additionally Plug-in logics may connect to a database and providers of a third party depending on its functionality and needs. For example, the plug-in logic objects may be of a weather display which may show the current weather info such as temperature, this plug-in for example may be connected to a weather information provider, so that the user will be able to see the weather update during his work with remote access application 300.

Remote access application 300 may add the plug-in logic object depending on the running program and/or user predefined configuration. Alternatively, the plug-in logic object may be a general plug-in object which may be displayed all the time independently of the running program and/or user configuration.

The plug-in logic object may be installed, for example, by using an installation interface (not shown) in wrapping tool 100. The plug-in logic object may then be transmitted to remote access application 300 via transfer module 180.

Advertising module 340 may connect to advertising provider's database to generate and display targeted advertisements according to the program for which the virtual wrap form is created. Advertising module 340 may use well known methods similar to Google's AdSense/AdWords and/or any other suitable method and/or mechanism and/or concept.

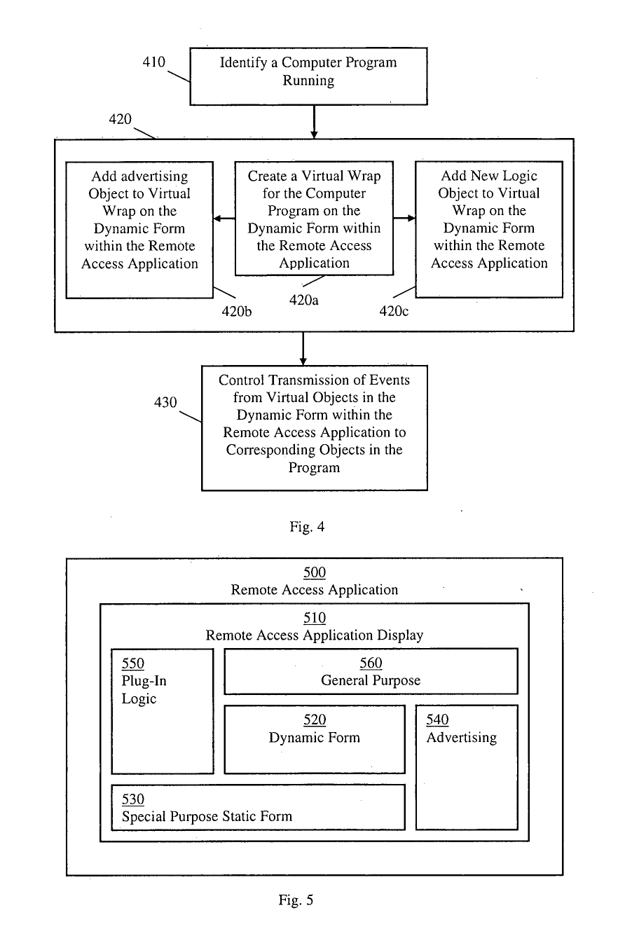

Reference is now made to FIG. 4, which is a flow chart illustrating a method for remote access to a computer program according to embodiments of the present invention. As illustrated in block 410, the method may include the step of identifying a computer program running, for example by program wrapping tool 100. As illustrated in block 420, the method may include the step of creating a virtual wrap for the computer program (block 420a), for example by dynamic form module 320 in remote access application 300 and/or according to instructions from a user as described in detail above and/or creating plug-in objects (block 420c) and/or advertising (block 420b). For example, predefined virtual wrap and/or wrapping instructions can be extracted from a data base, via connection module 180, as described in detail above. As described in detail above with reference to FIG. 3, the virtual wrap may include virtual objects which correspond to objects in the program. As illustrated in block 430, the method may include the step of controlling the transmission of events from virtual objects in the virtual wrap in the remote access application 300 to corresponding objects in the program, for example by an event manager in wrapping module 100 via connection module 180, for example as described in detail above with reference to FIG. 3.

Reference is now made to FIG. 5, which is an exemplary illustration of an exemplary remote access application 500 for remote access to a computer program according to some embodiments of the present invention. Exemplary remote access application 500 may include a remote access application display 510. Remote access application display 510 may include a dynamic virtual wrap form 520 created and operating as described above with reference to FIGS. 3 and 4. Additionally, remote access application display 510 may include a special purpose static form portion 530, an advertising portion 540, operated as described above with reference to FIGS. 3 and 4, a plug-in logic portion 550, operated as described above with reference to FIGS. 3 and 4, and a general purpose portion 560.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A computerized program wrapping tool, the computerized tool comprising:
an event agent to identify a computer program running; and
a form generator controlled by said event agent to create a virtual wrap for said computer program, said virtual wrap comprising virtual objects which correspond to objects in said program,
wherein said event agent is further to identify object events and to control the transmission of events from virtual objects in the virtual wrap to corresponding objects in said program.

2. The computerized tool according to claim 1, wherein the form generator is to create said virtual wrap automatically, upon a request from said event agent, in at least one of a web-page form and a window form.

3. The computerized tool according to claim 1, wherein the form generator is to create said virtual wrap automatically by dynamically creating based on a window form of said computer program resource files which comprise mechanism which can be loaded or/and run and/or executed by a web browser.

4. The computerized tool according to claim 1, wherein the form generator performs based on instructions from a user at least one of a list comprising translating text, changing text, changing font, changing color, changing size of text in a text object in the virtual wrap and changing alignment of text or object in accordance with the language.

5. The computerized tool according to claim 1, wherein the virtual wrap is in web-page form and can be accessed and remote-controlled by web-browsing.

6. The computerized tool according to claim 1, wherein the form generator is to interconvert a window form to a web-page form wrap, wherein each object in the web-form wrap correspond and/or operate correspondingly to a respective object in the window form.

7. The computerized tool according to claim 1, further comprising a data manager to manage a data base and to be controlled by said event agent to perform at least one of search for data, extract data, store data and/or update data in said data base.

8. A method for virtual wrapping of a computer program, the method comprising:
identifying a computer program running;
creating a virtual wrap for said computer program, said virtual wrap comprising virtual objects which correspond to objects in said program; and
controlling the transmission of identified object events from virtual objects in the virtual wrap to corresponding objects in said program.

9. The method according to claim 8, wherein said creating a virtual wrap is according to at least one of instructions from a user and predefined virtual wrap being kept in a data base.

10. The method according to claim 8, wherein said creating a virtual wrap is being done automatically, upon a request from said event agent, in at least one of a web-page form and a window form.

11. The method according to claim 8, wherein said creating a virtual wrap comprises performing based on instructions from a user at least one of a list comprising translating text, changing text, changing font, changing color, changing size of text in a text object in the virtual wrap and changing alignment of text or object in accordance with the language.

12. The method according to claim 8, wherein the virtual wrap is in web-page form and can be accessed and remote-controlled by web-browsing.

13. A method according to claim 8, further comprising creating and controlling at least one of a targeted advertising object and a plug-in logic object on the virtual wrap.

14. (canceled)

15. A system for remote access to a computer, the system comprising:
a wrapping tool for creating a virtual wrap for a computer program, said virtual wrap comprising virtual objects which correspond to objects in said program the wrapping tool comprising a transfer module for transferring information about the virtual wrap and events occurring in objects of the computer program; and
a remote application comprising:
a background communication manager to receive information from said transfer module; and
a dynamic form controlled through said background communication manager to create said virtual wrap for a computer program based on the information received from said transfer module.

16. A system according to claim 15, wherein said remote application further comprising a plug-in logic to add at least one logic object which does not exist in said program.

17. A system according to claim 15, wherein said remote application further comprising an advertising agent to display targeted advertising objects in the virtual wrap.

18. A system according to claim 17, wherein said advertising agent is to display targeted advertising objects which relate to said computer program.

19. A system according to claim 15, wherein said dynamic form is to create said virtual wrap automatically by dynamically creating based on a window form of said computer program resource files which comprise mechanism which can be loaded and/or run and/or executed by a web browser.

20. A system according to claim 15, wherein said dynamic form is to create said virtual wrap automatically by dynamically adding virtual object to existing windows form or/and web form based on a window form of said computer program.

21. A system according to claim 15, wherein said remote application is a window or web application within a website, and wherein said dynamic form is a module of said application and is to create said virtual wrap automatically by dynamically creating virtual objects for controlling corresponding objects in said program via said transfer module.

22. (canceled)
